(19) United States
(12) Patent Application Publication
(10) Pub. No.: US 2012/0089428 A1
(43) Pub. Date: Apr. 12, 2012

(54) PEN Analysis for Quantified Perspectives in Decision Making

(76) Inventor: Syamantak Saha, New York, NY (US)

(21) Appl. No.: 12/901,523

(22) Filed: Oct. 9, 2010

(51) Int. Cl. G06Q 90/00

(52) U.S. Cl. 705/7.11

(57) ABSTRACT

Organisations make decisions based on its Perspectives. These Perspectives exist within an environment with ever changing variables. It is of utmost importance that those Perspectives are relevant and valid in the current environment. Perspectives which are outdated or invalid, causes decisions and business activities which are inefficient for the Organisation. They will lead to business processes which are not integrated with the main thrust of the Organisation's workings. Hence, Perspectives need to be validated constantly, to ensure that all business processes are well integrated and exist in accordance to the objectives of the Organisation. However, there is no Analysis Technique which exists for Organisations to validate their Perspectives for Decision Making. In this paper, a Statistics based Analysis technique called PEN Analysis, is introduced. Using this technique, Organisations can validate their Perspectives for Decision Making and cumulative business process integration.

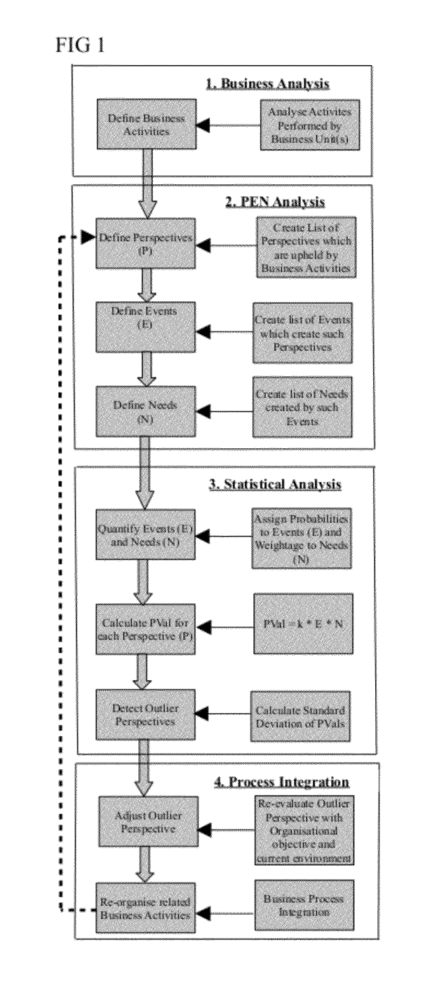

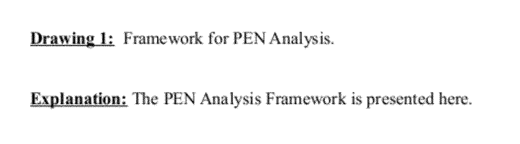

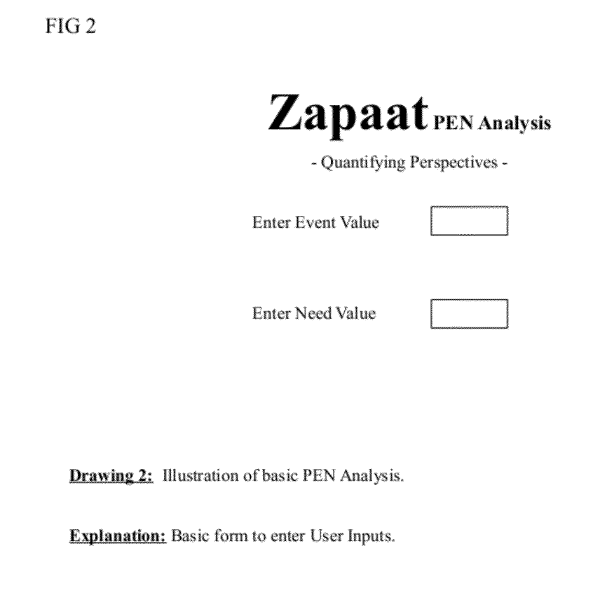

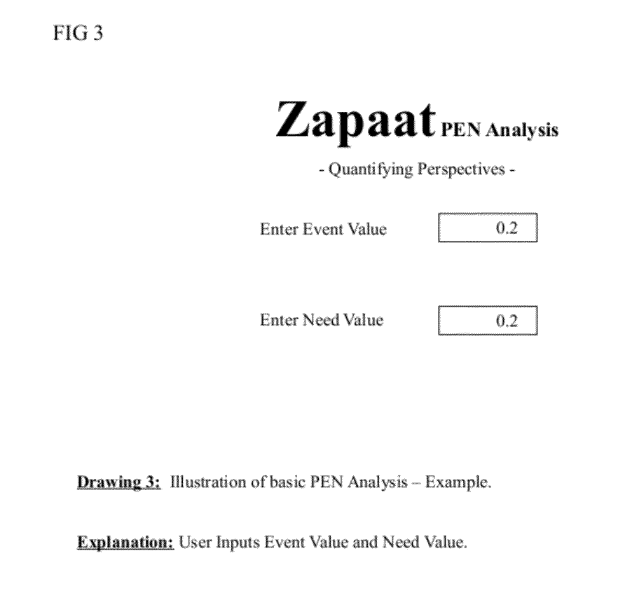

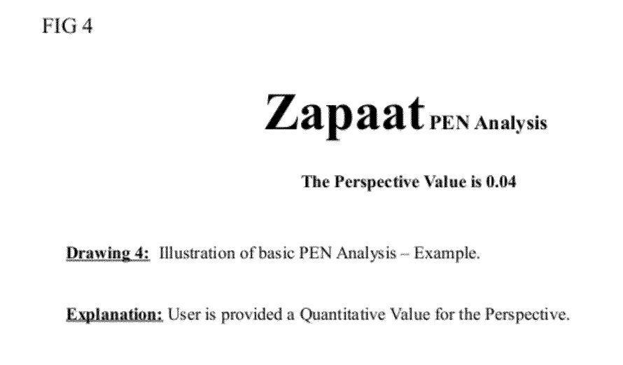

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF INVENTION

1. Field of the Invention
Software Engineering
Business Process Integration

2. Description of Related Art

Businesses use several Software Technologies to assist conducting their activities. Software Technologies can be used in most areas of business such as Customer Management, Sales and Finance. Using such technologies, businesses benefit hugely from improved processes. However, most of such technologies are for Operational purposes.

There is a need for a Software that would assist the Decision making process for Business Process Integration. Currently there exists no Software that serves such purposes. Having such a Software would enable businesses to make better Decisions.

### BRIEF SUMMARY OF THE INVENTION

PEN Analysis Software assists businesses to Quantify their Perspectives based on the Events and Needs that form the basis of the Perspective.

Having a Quantified Perspective would greatly benefit Businesses for Perspective comparison during Decision making.

An implementation of the basic Software can be accessed on the Internet at:

zapaat.com/pen

### BRIEF DESCRIPTION OF THE SEVERAL VIEWS OF THE DRAWING(S)

Drawing 1: Framework for PEN Analysis.

Explanation: The PEN Analysis Framework is presented here.

Drawing 2: Illustration of basic PEN Analysis.

Explanation: Basic form to enter User Inputs.

Drawing 3: Illustration of basic PEN Analysis—Example.

Explanation: User Inputs Event Value and Need Value.

Drawing 4: Illustration of basic PEN Analysis—Example.

Explanation: User is provided a Quantitative Value for the Perspective.

### DETAILED DESCRIPTION OF THE INVENTION

### Introduction

Organisations exists to meet a certain need of society. Organisations re-use the existing resources within society, add value to it, and produce a product or service which meets a particular need of society. The most optimal re-use of resources occur when there is an effective method of conducting business activities within the organisation.

Yet, the most effective method of conducting business activities is not always clear. As Businesses grow and as business activities are performed over extended period of time, the series of tasks which are carried out usually becomes an increasing list. Within this list of tasks, it is often difficult and sometimes impossible to identify which task is causing inefficiencies.

Nevertheless, the overhead of carrying out tasks which are inefficient, cause a massive hurdle for improving Organisational efficiency. Due to the effort which is drained on such inefficient activity, the losses of time and resources are exponential. If the particular business activity did not incur the inefficiency, then the Organisation would have produced a more efficient product or service.

### Need for Process Integration

As Organisations grow and as Business activities are conducted over an extended period of time, there becomes redundancies, overlaps and duplication of effort for various tasks. This is mostly the result of organic growth that an Organisation faces.

Due to this organic nature of an Organisation's growth, business tasks that accompany them are not always in a streamlined and organised manner. As a result, the branch node activity of a particular business unit could be very similar or exactly the same as that of another. Seldom will this be realised via current business processes, due to the definitive and business unit based Organisational structures. It is not common to compare how a business unit achieves its result, and whether it has any redundancies or overlaps. This inquiry, although undertaken occasionally, is not a common business practice. Nevertheless, there is a need to streamline and optimise business activities.

Organisations spend considerable effort in Business Analysis in order to find effective methods of conducting business. Through this analysis, at times, redundancies of activities are identified. However, seldom the redundancy can be resolved into a streamlined business process. This is mainly due to the historic relevance of particular tasks and that they have been carried out over several iterations of business activities. Importantly, there is no way to identify, despite the redundant nature of the task, that it can be re-organised or discarded, without disrupting the workings of the Organisation.

However, the most important need for process integration, is changing Perspectives. In character recognition problems, attempted recognition of characters under distorted Perception is an issue. Similarly, if business activities are performed with Perspectives which are not according to the environment and Organisational objectives, then such activities would cause inefficiencies for the Organisation. Business processes caused as a result of such Perspectives would require re-evaluation for process integration. Hence, to conduct business efficiently, Organisations need valid and relevant Perspectives to drive business activities in an integrated manner.

### How to Achieve Process Integration

In order to achieve business process integration, firstly, the tasks which are commonly carried out by the organisation have to be identified. This could span activities carried out by different business units, or by a specific business unit. Next, the co-relation between these tasks and that they are towards a common Organisational objective, has to be established. Although work has been done to provide Frameworks for process based performance measurement and knowledge accumulation, they are for operational purposes. They are not towards Organisational Perspectives of decision making, which are critical to business process integration.

Process integration involves not only cross checking with other activities, but also, more importantly, the utility of a particular activity when considered in light of the Organisation's Perspectives (P), Events (E) and Needs (N), which form the underlying reason for the Organisation's existence.

Perspectives (P) reflect how an Organisation interprets its environment in order to sustain its existence and growth. Such Perspectives are reflected in the Organisation's decision making and investments. Hence, it is of utmost importance that a business activity is in accordance to such Perspectives.

Events (E) are incidents which have occurred or have a possibility of occurring, and have an impact on the Organisation's existence and growth. Such Events form the basis of consideration for decision making and investments of the Organisation. Business Activities address such Events in order to insure sustained growth and existence. Hence, it is important that business activities are relatable to such Events.

Needs (N) of the Organisation are addressed through business activities. A business activity undertakes the task of meeting a particular Organisational Need. Without meeting the Needs of the Organisation, it threatens its existence and growth. Hence, every business activity should be relatable to a Need of the Organisation.

Current Business Practices define how an Organisation carries out the tasks for its existence and growth. They are the manifestations of the effort being expended by the Organisation through its resources. Hence, it is expected that all Current Business Practices have a utility towards the Organisation's Perspectives, Events and Needs. Although Petri-Net based knowledge verification and collection method have been suggested, their main objective is to improve operational processes, rather than the Perspectives behind Organisational decision making. A method to improve efficiency of Perspectives that drive Organisational decision making, is required.

The important elements for evaluating the efficiency of business practices, and hence business process integration, reside in the variables of P, E and N. To achieve process integration, a Quantitative Analysis of these variables is undertaken.

### Statiscal Modeling—Pen Analysis

Statistical Methods have been used to solve problems in diverse areas. To solve increasingly complex problems, a combination of reasoning and computation has to be adopted. In order to perform Quantitative Analysis, and thereby derive a model for Perspective validation for business process integration, we shall apply statistical methods on P, E and N.

As Perspectives (P) are held by Organisations, they are substantiated through Events (E) and Needs (N) that the Organisation deems relevant to its existence and growth. Hence, it can be derived that Perspectives (P) are directly related to Events (E) and Needs (N). A change in P can be co-related with changes in E and N.

Therefore,

P is directly proportional to E and N

i.e.

P∝E and N

Or,

P=k*E*N (formula 1)

where k is an arbitrary constant for computation purposes.

From formula 1, we can derive the value of P, let us call it the P Value, or PVal.

Let us assume that the relevant Perspectives (Px) of an Organisation, for a particular Business Activity, are:

### P1: Defining Perspective 1

### P2: Defining Perspective 2

### P3: Defining Perspective 3

### P4: Defining Perspective 4

Let us consider P1 for our analysis purposes.

For P1 there would be related Events (E) that influences the existence of P1. Due to such Events (E), the Organisation deems it important and relevant to hold onto Perspectives of P1.

As Events (E), are defined by critical Events which effect the Organisation's workings, a quantitative representation of E would be the probability of occurrences of E, for the given Perspective (P1).

Let us assume the following Events (Ex) that cause Perspective (P1):

### E1: Defining Event 1

### E2: Defining Event 2

### E3: Defining Event 3

### E4: Defining Event 4

Hence,

| Perspective (P) | Event (E) | Probability (PrE) |
|---|---|---|
| P1 | E1 | PrE(E1) |
| P1 | E2 | PrE(E2) |
| P1 | E3 | PrE(E3) |
| P1 | E4 | PrE(E4) |

For every Event (E), there would be a specific Need (N) which arises out of it. Since an Event (E) has possibility of occurring, inherently, it introduces the Need (N) to address that Event (E).

Let us assume that the following Needs (Nx) are caused due to each of the Events (Ex):

### E1: N1: Defining Need 1

### E2: N2: Defining Need 2

### E3: N3: Defining Need 3

### E4: N4: Defining Need 4

The Need (N) of the Organisation can be quantitatively represented as the Weightage of the Need. That is, the importance of the Need and its contribution to the whole of Organisation's workings, can be represented through the Weightage attributed to the Need.

Hence,

| Perspective(P) | Event(E) | Need(N) | Weightage(wN) |
|---|---|---|---|
| P1 | E1 | N1 | wN(N1) |
| P1 | E2 | N2 | wrN(N2) |
| P1 | E3 | N3 | wN(N3) |
| P1 | E4 | N4 | wN(N4) |

As derived in formula 1 earlier,

P=k*E*N

So the P Value of P1 can be represented as:

PVal(P1)=k*((PrE(E1)*wN(N1))+(PrE(E2)*wN(N2))+(PrE(E3)*wN(N3))+(PrE(E4)*wN(N4))) formula 2

Generically, then, for n Events and Needs for a given Perspective (Px), its PVal can be represented as:

PVal(Px)=k*((PrE(E1)*wN(N1))+ . . . +(PrE(En)*wN(Nn))) formula 3

### Efficiency Analysis

From the calculated values of PVal we can proceed to analyse the efficiency of each Perspective, represented quantitatively by their respective PVals.

The Standard Deviation (SD) of a distribution represents the most likely deviation of each value within the distribution, from their Mean.

The Outliers (O) are the values within the distribution which are more than a Standard Deviation away from the Mean of the distribution.

Hence, if we identify the Outliers (O) within the given values of PVal, we will identify those Perspectives which are away from the main thrust of the Organisation's workings. Thereby, those Perspectives can be looked into and addressed to increase the overall efficiency of the Organisation's throughput. Business activities which correspond to such Perspectives, can also be re-organised to achieve process integration.

To proceed accordingly, first we have to calculate the Mean of the PVals.

Mean(PVal)=(PVal(P1)+PVal(P2) . . . +PVal(Pn))/n formula 5

where n is the number of PVals being considered.

The SD of the PVals can be given by:

.. formula 6

| SD(PVal) = Square_Root ( | |
|---|---|
| | Square(Mean(PVal) − PVal(P1)) |
| + | Square(Mean(PVal) − PVal(P2)) |
| .. | |
| + | Square(Mean(PVal) − PVal(Pn))/n |
| | ) |

Now, the Deviation (D) of each PVal from the Mean is:

D(P1)=abs(Mean(PVal)−PVal(P1))

D(P2)=abs(Mean(PVal)−PVal(P2))

. . .

D(Pn)=abs(Mean(PVal)−PVal(Pn)) formula 7

where abs denotes taking the absolute value.

To detect the Outliers (O) within the distribution of PVal, we find those values of PVal whose D(Px) is greater than the SD(PVal).

Hence,

If D(P1)>SD(PVal) then Perspective P1 is an Outlier

If D(P2)>SD(PVal) then Perspective P2 is an Outlier

. . .

If D(Pn)>SD(PVal) then Perspective Pn is an Outlier formula 8

From the above PEN Analysis Technique, we can identify those Perspectives (P) which are Outliers (O), and are away from the main thrust of the Organisation's workings. Corresponding business activities cause inefficiencies for the Organisation. To achieve business process integration, such Outlier Perspectives have to be re-validated and re-organised according to the Organisation objectives and current environment.

### Example PEN Analysis

An example PEN Analysis can now be applied. For this, we consider the Marketing Activities of a Bank. The Bank seeks more Customers to buy its Products. The Bank sets up Marketing Campaigns which are generated and distributed by the Bank's Marketing Department.

In this example, the Business Activity being considered, is the Marketing Campaign generation for winning new Customers. For this business activity, we want to analyse whether the Perspectives which drive this initiative are valid, and that the processes involved are integrated.

For PEN Analysis, we consider the Perspectives (P), Events (E) and Needs (N) that are involved.

### Perspectives (P)

P1: New Products will attract new Customers
P2: Appealing through Marketing Campaigns will win new Customers
P3: Customer Segmentation will win new Customers

### Events (E)

P1: E1: Previous launch of new Product won new Customers
P1: E2: Without new Products, competitors will get more Customers
P2: E3: Marketing Campaigns raise product awareness among potential Customers
P2: E4: Potential Customers response to Campaigns leads to winning new Customers
P3: E5: Customer Segmentation defines the Customers who are reached through Marketing Campaigns
P3: E6: Without Customer Segmentation, appropriate Campaigns cannot be developed

### Needs (N)

### P1: E1: N1: Develop new Products

P1: E2: N2: Competitive edge through new Products
P2: E3: N3: Inform potential Customers of new Products
P2: E4: N4: Capture Campaign response from potential Customers

### P3: E5: N5: Create Customer Segmentation

P3: E6: N6: Develop Marketing Campaigns specifically for particular Customer Segment

Now, we have to assign Probability of each Event and Weight for each Need. They are provided by Decision Makers who have extensive knowledge of the Organisation's Business. The influencers of these values are their past occurrences, and the perception or feeling of the Decision Maker for the Need and Event, in a combination that is appropriately represented by such values.

For example, to assign the Probability for Event (E1), the actual happening of the Event has to be considered. For P1: E1, it is found that from the last 10 launches of a new product, on 7 occasions, new Customers were won. Also, there is a 90% confidence that new products will attract new Customers.

To be noted, that the value of 7 times out of 10, is taken from historic data, and the confidence value of 90%, is from the perception or feeling of the Decision Maker. Together, they contribute to the final value of PrE(E1).

So, the probability value for P1: E1 can be assigned as:

$$\begin{matrix}PrE ( E 1 ) = ( 7 / 10 ) * ( 90 / 100 ) \\ = 0.63\end{matrix}$$

Similarly, the Probabilities for the other Events are assigned.

### PrE Assignment

| Perspective (P) | Event (E) | Probability (PrE) |
|---|---|---|
| P1 | E1 | 0.60 |
| P1 | E2 | 0.40 |
| P2 | E3 | 0.70 |
| P2 | E4 | 0.60 |
| P3 | E5 | 0.10 |
| P3 | E6 | 0.20 |

To assign Weightage for Needs, the Decision Maker expresses the importance of the Need to the Organisation. On a scale of 1 to 10, the Decision Maker assigns the importance of the Need from the whole of Organisation's workings.

For example, for E1: N1, it is felt that its importance is 7 on a scale of 10. Hence Weightage(N1):

wN(N1)=7/10=0.70

Here, the value of wN(N) is completely derived from the perception or feeling of the Decision Maker for the importance of the Need to the whole of Organisation workings.

Similarly, the Weightage of other Events are assigned.

### wN Assignment

| Perspective(P) | Events(E) | Needs(N) | Weightage(wN) |
|---|---|---|---|
| P1 | E1 | N1 | 0.70 |
| P1 | E2 | N2 | 0.60 |
| P2 | E3 | N3 | 0.60 |
| P2 | E4 | N4 | 0.50 |
| P3 | E5 | N5 | 0.40 |
| P3 | E6 | N6 | 0.30 |

Now, we can proceed to calculate the PVals of each P.

We take the value of k=0.5

From formula 2,

$$\begin{matrix}PVal ( P 1 ) = k * ( ( Pr ( E 1 ) * wN ( N 1 ) ) + ( Pr ( E 2 ) * wN ( N 2 ) ) \\ = 0.5 * ( ( 0.60 * 0.70 ) + ( 0.40 * 0.60 ) ) \\ = 0.5 * ( 0.42 + 0.24 ) \\ = 0.5 * ( 0.66 ) \\ = 0.330\end{matrix}$$

$$\begin{matrix}PVal ( P 2 ) = k * ( ( Pr ( E 3 ) * wN ( N 3 ) ) + ( Pr ( E 4 ) * wN ( N 4 ) ) \\ = 0.5 * ( ( 0.70 * 0.60 ) + ( 0.60 * 0.50 ) ) \\ = 0.5 * ( 0.42 + 0.30 ) \\ = 0.5 * ( 0.72 ) \\ = 0.360\end{matrix}$$

$$\begin{matrix}PVal ( P 3 ) = k * ( ( Pr ( E 5 ) * wN ( N 5 ) ) + ( Pr ( E 6 ) * wN ( N 6 ) ) \\ = 0.5 * ( ( 0.10 * 0.40 ) + ( 0.20 * 0.30 ) ) \\ = 0.5 * ( 0.10 ) \\ = 0.05\end{matrix}$$

The Mean of PVals is,

$$\begin{matrix}Mean ( PVal ) = ( PVal ( P 1 ) + PVal ( P 2 ) + PVal ( P 3 ) ) / 3 \\ = ( 0.330 + 0.360 + 0.050 ) / 3 \\ = 0.247\end{matrix}$$

The Standard Deviation of PVals is,

| SD(PVal) = Square_Root ( | |
|---|---|
| | (Square(Mean(PVal) − PVal(P1)) |
| + | Square(Mean(PVal) − Pval(P2)) |
| + | Square(Mean(PVal) − Pval(P3))/3) |
| | ) |

= Square_Root (

(0.007 + 0.013 + 0.039)/3)

= 0.140

Deviation (D) of PVals,

$$\begin{matrix}D ( P 1 ) = abs ( Mean ( PVal ) - PVal ( P 1 ) ) \\ = abs ( 0.247 - 0.330 ) \\ = 0.083\end{matrix}$$

$$\begin{matrix}D ( P 2 ) = abs ( Mean ( PVal ) - PVal ( P 2 ) ) \\ = abs ( 0.247 - 0.360 ) \\ = 0.113\end{matrix}$$

$$\begin{matrix}D ( P 3 ) = abs ( Mean ( PVal ) - PVal ( P 3 ) ) \\ = abs ( 0.247 - 0.050 ) \\ = 0.197\end{matrix}$$

Next, we perform the Outlier Detection of PVals. For that we compare the D(Px) with the SD(PVal). Any D(Px) which is greater than the SD(PVal) is considered to be an Outlier.

Compared to the SD(PVal) of 0.140, we observe that D(P3), with a value of 0.197, is an Outlier.

Perspective P3 is defined as

P3: Customer Segmentation will win new Customers

From PEN Analysis, it is found that this Perspective is inefficient for the Organisation's workings

The value of Perspective P3 was to create Customer Segments for Marketing Campaigns. To validate this Perspective, the profiles of the new Customer are analysed. It is found that several of the new Customers do not belong to the Customer Segment for which the Marketing Campaign was generated. It is realised that there is neither the need nor the appropriate method available for the Marketing Campaigns to be targeted at specific Customer Segments only. All Customers, regardless of their Segment, are reached through the Marketing Campaign, and equally, new Customers won, belong to all segments.

It is decided that Customer Segmentation is not of much value, as Customers are won from all segments as a result of the Campaign.

As a result of PEN Analysis, the inefficient process of Customer Segmentation is identified, and decided to be deleted from the existing business activities for Campaign generation.

Iterative PEN Analysis on the Business Activities of Campaign Generation for attracting new Customers, are performed. Finally, a set of business activities are achieved where there are no Outlier Perspectives, and as a result, the business processes are integrated.

### Pen Framework

### Step 1: Business Analysis

In this step, a group of Business Activities performed by Business Unit(s), for a specific purpose of the Organisation, is analysed. The various activities are discovered and listed.

### Step 2: PEN Analysis

From the various Activities that are performed, PEN Analysis is undertaken.

The Perspectives (P) which are upheld by the Business Activities are defined and listed.

The Events (E) which causes the creation of such Perspectives are defined and listed.

The Needs (N) which arise due to such Events are defined and listed.

### Step 3: Statistical Analysis

To each of the Events (E) which have been listed, a Probability value quantifying the chances of them occurring, is assigned.

To each of the Needs (N) which have been listed, a Weightage value quantifying their importance, is assigned.

The value of each of the Perspectives is calculated as their PVal, using the Probabilities of Event (E) and Weightage of (N).

The Standard Deviation for the PVals are calculated. From them, the Outlier PVals are identified.

### Step 4: Process Integration

The Perspectives corresponding to the Outlier PVals are re-evaluated with Organisational objectives and current environment, and the corresponding Business Activities are re-organised.

Organisational efficiency is improved through the business process integration which is achieved.

### Iterations

Step 2 to Step 4 are repeated till there are no Outliers Detected.

### CONCLUSION

Organisations exist in an ever changing environment. Decisions have to be made considering variables which are quite relative and dynamic. Perspectives grow from the perceptions of this dynamic environment. Decisions are made based on these Perspectives.

Often, Perspectives which are behind the decision making process, needs re-evaluation. As the environmental variables change, it demands that the Perspectives of the Organisation be re-visited. However, there is seldom a reason to re-visit existing Perspectives, purely based on Organisational Activities. As Business exists and is operating in the required manner, the justification for such Perspective re-evaluation is seldom apparent. However, extensive Organisational performance gain can be achieved by identifying and addressing Activities which are based on Perspectives that are superseded due to the changing environment. However, even if this is realised, there was no Framework or Analysis Method that could have been adopted for such initiatives.

In this paper, a Method to Analyse Perspectives and their real value to the Organisation, is discussed and presented, as the PEN Analysis Method. Using this technique, Organisations can identify business activities driven by Perspectives which are inefficient for Organisational Performance. Through iterative PEN Analysis, Organisations can integrate Business Activities and Processes in accordance to its objectives and current environment, thereby improving its performance.

1. No other Software provides a Method for Quantitative Analysis of Perspectives for Decision Making.
